(19) United States
(12) Patent Application Publication
(10) Pub. No.: US 2017/0346978 A1
(43) Pub. Date: Nov. 30, 2017

(54) WAKE-UP CONTROL DEVICE, IMAGE PROCESSING APPARATUS, AND NON-TRANSITORY COMPUTER READABLE MEDIUM

(71) Applicant: FUJI XEROX CO., LTD., Tokyo (JP)

(72) Inventors: Yoshifumi BANDO, Kanagawa (JP); Yuichi KAWATA, Kanagawa (JP); Hideki YAMASAKI, Kanagawa (JP); Ryoko SAITOH, Kanagawa (JP); Kensuke OKAMOTO, Kanagawa (JP); Tomoyo NISHIDA, Kanagawa (JP)

(73) Assignee: FUJI XEROX CO., LTD., Tokyo (JP)

(21) Appl. No.: 15/362,661

(22) Filed: Nov. 28, 2016

(30) Foreign Application Priority Data
May 26, 2016 (JP) 2016-104898

(51) Int. Cl. H04N 1/00

(52) U.S. Cl. CPC H04N 1/00891; H04N 1/00896; H04N 1/00129; H04N 1/00037; H04N 1/00058; H04N 1/00082

(57) ABSTRACT

A wake-up control device includes a detector and a wake-up unit. When an apparatus is in a power-saving state in which power consumption is lower than power consumption in a normal state, the detector detects a hand or finger approaching an operation unit operated in order to perform a wake-up operation of changing a state of the apparatus from the power-saving state to the normal state. In the case where the apparatus is in the power-saving state, if the detector detects a hand or finger approaching the operation unit, even when the operation unit has not been operated, the wake-up unit performs a wake-up operation of changing the state of the apparatus from the power-saving state to the normal state.

### CROSS-REFERENCE TO RELATED APPLICATIONS

This application is based on and claims priority under 35 USC 119 from Japanese Patent Application No. 2016-104898 filed May 26, 2016.

### BACKGROUND

### Technical Field

The present invention relates to a wake-up control device, an image processing apparatus, and a non-transitory computer readable medium.

### SUMMARY

According to an aspect of the invention, there is provided a wake-up control device including a detector and a wake-up unit. When an apparatus is in a power-saving state in which power consumption is lower than power consumption in a normal state, the detector detects a hand or finger approaching an operation unit operated in order to perform a wake-up operation of changing a state of the apparatus from the power-saving state to the normal state. In the case where the apparatus is in the power-saving state, if the detector detects a hand or finger approaching the operation unit, even when the operation unit has not been operated, the wake-up unit performs a wake-up operation of changing the state of the apparatus from the power-saving state to the normal state.

### BRIEF DESCRIPTION OF THE DRAWINGS

Exemplary embodiment of the present invention will be described in detail based on the following figures, wherein:

FIG. 1 is a diagram illustrating an exemplary hardware configuration of an image processing apparatus according to an exemplary embodiment of the present invention;

FIG. 2 is a block diagram illustrating an exemplary functional configuration of a wake-up control device according to the exemplary embodiment of the present invention;

FIG. 3 is a diagram illustrating exemplary position comparison information stored in a position-comparison information memory according to the exemplary embodiment of the present invention;

FIG. 4 is a diagram illustrating exemplary characteristics comparison information stored in a characteristics-comparison information memory according to the exemplary embodiment of the present invention; and

FIG. 5 is a flowchart illustrating exemplary operations performed by the wake-up control device according to the exemplary embodiment of the present invention.

### DETAILED DESCRIPTION

Referring to the attached drawings, an exemplary embodiment of the present invention will be described in detail below.

### Hardware Configuration of Image Processing Apparatus

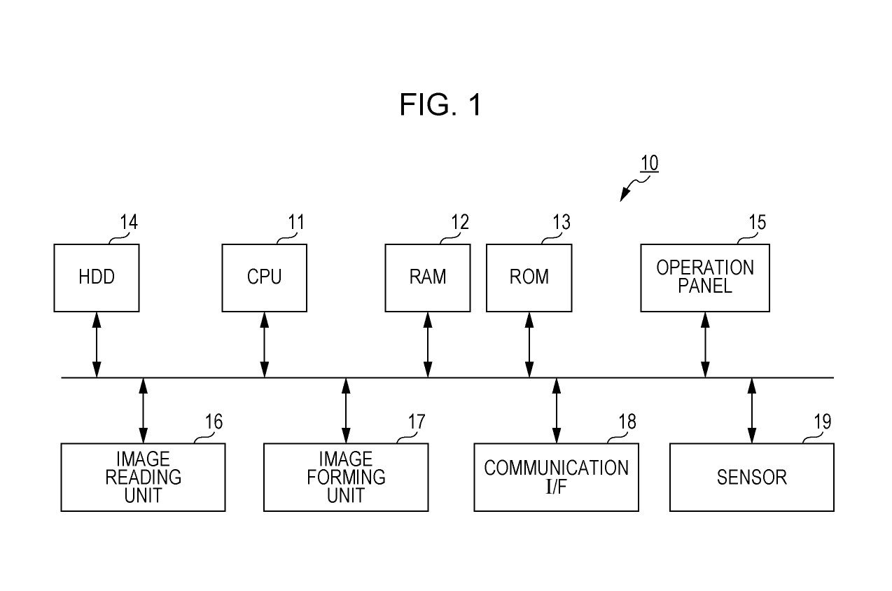

FIG. 1 is a diagram illustrating an exemplary hardware configuration of an image processing apparatus 10 according to the exemplary embodiment. As illustrated, the image processing apparatus 10 includes a central processing unit (CPU) 11, a random access memory (RAM) 12, a read only memory (ROM) 13, a hard disk drive (HDD) 14, an operation panel 15, an image reading unit 16, an image forming unit 17, a communication interface (hereinafter designated as a “communication I/F”) 18, and a sensor 19.

The CPU 11 loads various programs stored in the ROM 13 and the like into the RAM 12, and executes the programs so that the functions described below are achieved.

The RAM 12 is a memory used as a work memory or the like of the CPU 11.

The ROM 13 is a memory used to store various programs and the like executed by the CPU 11.

The HDD 14 is, for example, a magnetic disk device which stores image data obtained through a reading operation performed by the image reading unit 16, image data used in image formation performed by the image forming unit 17, and the like.

The operation panel 15 includes a display for displaying various types of information, and a keyboard with which a user performs input of operations. The display may be a touch panel provided with a position detecting sheet for detecting a position indicated by using a finger, a stylus pen, or the like. The keyboard includes a start button, numeric keys, and the like.

The image reading unit 16 reads an image that has been recorded on a recording medium such as paper. The image reading unit 16 is, for example, a scanner for which a charge coupled device (CCD) system or a contact image sensor (CIS) system may be employed. The CCD system is a system in which light that is emitted from a light source to a document and that is then reflected from the document is reduced by using a lens and in which the reduced light is received by CCDs. The CIS system is a system in which light that is emitted sequentially from light-emitting diode (LED) light sources to a document and that is then reflected from the document is received by using a CIS.

The image forming unit 17 forms an image on a recording medium. The image forming unit 17 is, for example, a printer for which an electrophotographic system or an inkjet system may be employed. The electrophotographic system is a system in which an image is formed by transferring toner attached to a photoreceptor onto a recording medium. The inkjet system is a system in which an image is formed by ejecting ink on a recording medium.

The communication I/F 18 receives/transmits various types of information from/to another apparatus through a communication line (not illustrated).

The sensor 19 which includes a light emitting unit and a light receiving unit three-dimensionally detects the position and characteristics of a hand or finger in such a manner that the light receiving unit detects reflected light produced from light emitted from the light emitting unit. As the light emitting unit, three infrared LEDs may be used. As the light receiving unit, a single infrared camera may be used. However, this is merely an example. In particular, the number of components depends on the shape of the image processing apparatus 10.

### Overview of Exemplary Embodiment

In the exemplary embodiment, in the case where the image processing apparatus 10 is in the power-saving state in which power consumption is lower than that in the normal state, if a hand or finger approaching an operation unit is detected, the image processing apparatus 10 may be woken up from the power-saving state and may enter the normal state even when the operation unit has not been operated.

An operation unit is a component operated when an instruction to perform image processing is to be transmitted. Such an operation unit encompasses not only the operation panel 15 but also, for example, a platen on which a document is put when the image reading unit 16 performs an image reading operation. In the exemplary embodiment, when an operation unit is to be operated by using a finger, position information and characteristics information of its hand or the finger are obtained. For the sake of simplicity of the description below, a “hand or finger” is expressed as a “hand” which means a hand area from its wrist to its fingertips.

### Configuration of Wake-Up Control Device

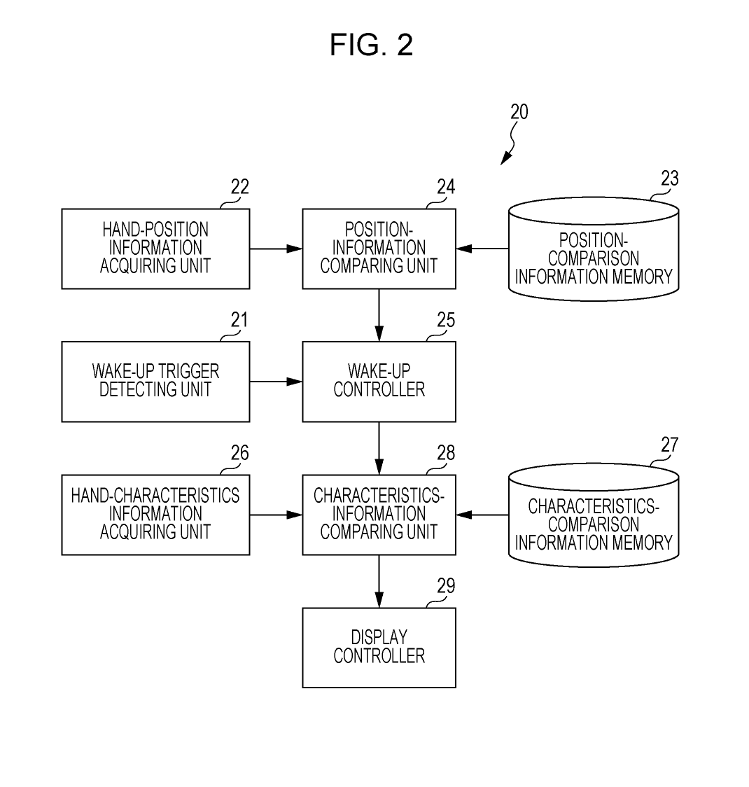

FIG. 2 is a block diagram illustrating an exemplary functional configuration of a wake-up control device 20 according to the exemplary embodiment. The wake-up control device 20 is regarded as a device implemented in such a manner that the CPU 11 (see FIG. 1) of the image processing apparatus 10 reads programs for implementing the functional units described below, for example, from the ROM 13 (see FIG. 1) to the RAM 12 (see FIG. 1), and executes the programs. As illustrated, the wake-up control device 20 includes a wake-up trigger detecting unit 21, a hand-position information acquiring unit 22, a position-comparison information memory 23, a position-information comparing unit 24, a wake-up controller 25, a hand-characteristics information acquiring unit 26, a characteristics-comparison information memory 27, a characteristics-information comparing unit 28, and a display controller 29.

The wake-up trigger detecting unit 21 detects a wake-up trigger other than a wake-up trigger produced by an operation performed on an operation unit by using a hand, among wake-up triggers for performing a wake-up operation of changing the state of the image processing apparatus 10 from the power-saving state to the normal state. Examples of a wake-up trigger other than a wake-up trigger produced by an operation performed on an operation unit by using a hand include reception of print data and the like transmitted through a communication line (not illustrated).

When an operation unit is going to be operated by using a hand, the sensor 19 detects the position of the hand. Accordingly, the hand-position information acquiring unit 22 obtains hand position information indicating the detected position. The hand position information may be expressed as coordinates (X_{H}, Y_{H}, Z_{H}) in a three-dimensional space.

The position-comparison information memory 23 which is implemented, for example, by using the HDD 14 (see FIG. 1) is used to store position comparison information for each type of operation unit. In the position comparison information, operation-unit surrounding-space position information indicating a position near an operation unit is associated with comparison time information indicating the length of a comparison time which is a time for which the hand position information is compared with the operation-unit surrounding-space position information. The operation-unit surrounding-space position information may be expressed as coordinates (X_{O}, Y_{O}, Z_{O}) in a three-dimensional space, and the comparison time information may be expressed as time T. Specific examples of the position comparison information will be described below.

To detect a hand approaching an operation unit, the position-information comparing unit 24 compares the hand position information obtained by the hand-position information acquiring unit 22 with each piece of the operation-unit surrounding-space position information included in the position comparison information stored in the position-comparison information memory 23. The position-information comparing unit 24 determines whether or not the hand position information continuously matches any piece of the operation-unit surrounding-space position information for the duration of the comparison time indicated in the comparison time information corresponding to the piece of the operation-unit surrounding-space position information. The term “match” does not mean an exact match, but means a match within a range. That is, while the position indicated in the hand position information is continuously located within the space in a rectangular parallelepiped whose center is located at the position indicated in a piece of the operation-unit surrounding-space position information, for the duration of the comparison time indicated in the comparison time information corresponding to the piece of the operation-unit surrounding-space position information, it is determined that these positions continuously match each other. Specifically, while expressions X_{H}≦X_{O}±ΔX, Y_{H}≦Y_{O}±ΔY, and Z_{H}≦Z_{O}±ΔZ continuously holds for time T, it is determined that (X_{H}, Y_{H}, Z_{H}) continuously matches (X_{O}, Y_{O}, Z_{O}). In the exemplary embodiment, the position-information comparing unit 24 is provided as an exemplary detector which detects a hand or finger approaching an operation unit. As described above, the space in a rectangular parallelepiped whose center is located at a position indicated in the operation-unit surrounding-space position information is used. The term “operation-unit surrounding-space” indicates a space near the operation unit, and the rectangular parallelepiped may be any solid figure. Therefore, the space in a rectangular parallelepiped is an exemplary predetermined space whose center is located at a position located near an operation unit. The comparison time is an exemplary predetermined time.

When it is determined that the hand position information continuously matches a piece of the operation-unit surrounding-space position information for the duration of the comparison time indicated in the comparison time information corresponding to the piece of the operation-unit surrounding-space position information, the wake-up controller 25 controls a power supply unit (not illustrated) so that the image processing apparatus 10 is woken up from the power-saving state and enters the normal state. In the exemplary embodiment, the wake-up controller 25 is provided as an exemplary wake-up unit which performs a wake-up operation of changing the state of an image processing apparatus from the power-saving state to the normal state.

When an operation unit is going to be operated by using a hand, the sensor 19 also detects characteristics of the hand. Accordingly, the hand-characteristics information acquiring unit 26 obtains hand characteristics information indicating the detected characteristics. Characteristics of a hand include the size of a hand, the length of a finger, and the width of a finger. In the description below, the length and width of a finger is taken as exemplary characteristics of a hand. In this case, the obtained hand characteristics information may be expressed as a combination (L_{A}, W_{A}) of the length and width of a finger.

The characteristics-comparison information memory 27 which is implemented, for example, by using the HDD 14 (see FIG. 1) is used to store characteristics comparison information in which hand characteristics information indicating hand characteristics is associated with display format information indicating a display format suitable for the hand characteristics. The hand characteristics information included in the characteristics comparison information may be expressed as a combination (L_{R}, W_{R}) of the length and width of a finger. Specific examples of the characteristics comparison information will be also described.

The characteristics-information comparing unit 28 compares the hand characteristics information obtained by the hand-characteristics information acquiring unit 26 with each piece of the hand characteristics information included in the characteristics comparison information stored in the characteristics-comparison information memory 27. The characteristics-information comparing unit 28 determines whether or not the obtained hand characteristics information matches any piece of the hand characteristics information included in the characteristics comparison information. The term “match” does not mean an exact match, but means a match within a range. That is, when characteristics indicated in the obtained hand characteristics information fall within a predetermined range in which the characteristics at the center are the characteristics indicated in a piece of the hand characteristics information included in the characteristics comparison information, it is determined that these characteristics sets match each other. Specifically, when the expressions L_{A}≦L_{R}±ΔL and W_{A}≦W_{R}±ΔW hold, it is determined that (L_{A}, W_{A}) matches (L_{R}, W_{R}).

When it is determined that the obtained hand characteristics information matches a piece of the hand characteristics information included in the characteristics comparison information, the display controller 29 obtains display format information corresponding to the hand characteristics information, and controls the operation panel 15 so that a user interface (UI) screen in the display format indicated in the display format information is displayed on a display. Examples of the display format include the icon size and spacing, the character size and spacing, and the mode indicating whether Chinese characters or hiragana characters are to be displayed. Among these examples, the mode indicating whether Chinese characters or hiragana characters are to be displayed may be switched depending on whether the user is a child or an adult, that is, depending on the user's age. In the exemplary embodiment, the display controller 29 is provided as an exemplary display unit which displays information on a display screen for an operation unit.

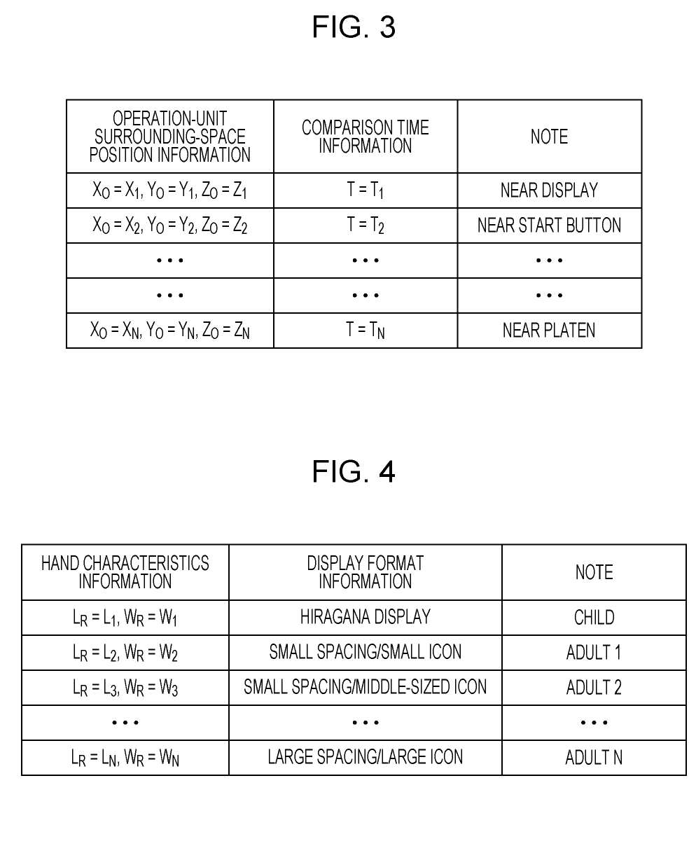

The position comparison information stored in the position-comparison information memory 23 will be described. FIG. 3 is a diagram illustrating exemplary position comparison information. As illustrated, the position comparison information includes a record for each type of operation unit. In this example, records for a display, a start button, and a platen are illustrated. Each record includes operation-unit surrounding-space position information indicating a position in a surrounding space of an operation unit, and comparison time information which indicates the length of a comparison time which is a time for which the hand position information is compared with the operation-unit surrounding-space position information. In the operation-unit surrounding-space position information, X_{O}, Y_{O}, and Z_{O} respectively indicate an X coordinate, a Y coordinate, and a Z coordinate in a three-dimensional space which indicate a position in a surrounding space of an operation unit. In the comparison time information, T indicates the length of a comparison time. Values T₁ to T_{N} are set to the comparison time T. It may be assumed that a user who is going to touch a display wants to wake up the apparatus from the power-saving state in a short time. Therefore, T₁ may be set smaller than T₂ and T_{N}. In FIG. 3, the type of an operation unit is described as a note. This is illustrated to facilitate the description, and the note information is not included in the position comparison information.

The characteristics comparison information stored in the characteristics-comparison information memory 27 will be described. FIG. 4 is a diagram illustrating exemplary characteristics comparison information. As illustrated, the characteristics comparison information includes a record for each type of user. In this example, records for a child and adults 1 to N are illustrated. Each record includes the hand characteristics information indicating the length and width of a finger and the display format information indicating a display format of a UI screen suitable for the length and width of a finger. In the hand characteristics information, L_{R} indicates the length of a finger, and W_{R} indicates the width of a finger. In the display format information, “spacing” indicates a spacing between icons, and “icon” indicates an icon size. In FIG. 4, a user type is illustrated as a note. This is illustrated to facilitate the description, and the note information is not included in the characteristics comparison information.

### Operations Performed by Wake-Up Control Device

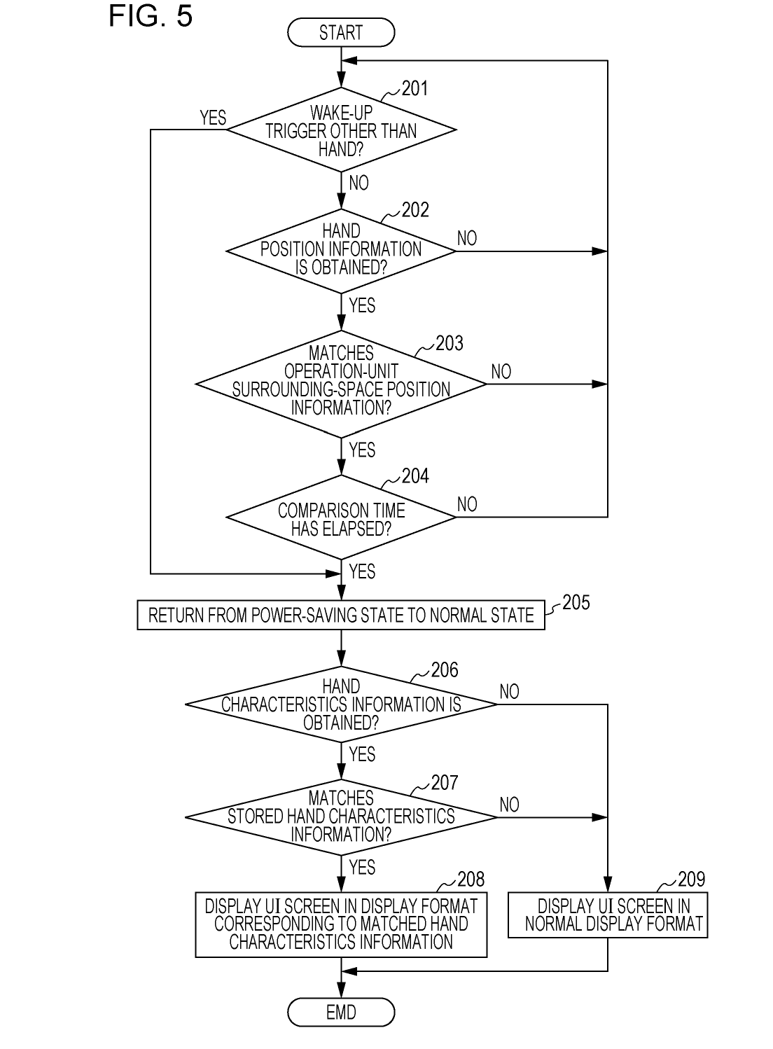

FIG. 5 is a flowchart illustrating exemplary operations performed by the wake-up control device 20 according to the exemplary embodiment.

When the process starts, the wake-up control device 20 determines whether or not the wake-up trigger detecting unit 21 has detected a wake-up trigger other than a wake-up trigger produced by an operation performed on an operation unit by using a hand (step 201). If the wake-up trigger detecting unit 21 determines that a wake-up trigger other than a wake-up trigger produced by an operation performed on an operation unit by using a hand has been detected, the process proceeds to step 205.

If the wake-up trigger detecting unit 21 does not determine that a wake-up trigger other than a wake-up trigger produced by an operation performed on an operation unit by using a hand has been detected, the hand-position information acquiring unit 22 determines whether or not hand position information indicating the position of a hand with which an operation unit is going to be operated has been obtained from the sensor 19 (step 202). If the hand-position information acquiring unit 22 does not determine that hand position information indicating the position of a hand with which an operation unit is going to be operated has been obtained from the sensor 19, the process returns back to step 201.

If the hand-position information acquiring unit 22 determines that hand position information indicating the position of a hand with which an operation unit is going to be operated has been obtained from the sensor 19, the position-information comparing unit 24 determines whether or not the obtained hand position information matches any piece of the operation-unit surrounding-space position information included in the position comparison information stored in the position-comparison information memory 23 (step 203). Specifically, it is determined whether or not the position indicated in the obtained hand position information is present in the space in a rectangular parallelepiped whose center is located at the position indicated in any piece of the operation-unit surrounding-space position information. If the position-information comparing unit 24 does not determine that the obtained hand position information matches a piece of the operation-unit surrounding-space position information, the process returns back to step 201.

If the position-information comparing unit 24 determines that the obtained hand position information matches a piece of the operation-unit surrounding-space position information, the position-information comparing unit 24 determines whether or not the hand position information continuously matches the operation-unit surrounding-space position information until the comparison time corresponding to the operation-unit surrounding-space position information in the position comparison information stored in the position-comparison information memory 23 has elapsed (step 204). If the position-information comparing unit 24 does not determine that the hand position information continuously matches the operation-unit surrounding-space position information until the comparison time has elapsed, the process returns back to step 201. In contrast, if the position-information comparing unit 24 determines that the hand position information continuously matches the operation-unit surrounding-space position information until the comparison time has elapsed, the process proceeds to step 205.

If a wake-up trigger other than a wake-up trigger produced by an operation performed on an operation unit by using a hand has been detected in step 201, or if, in step 204, it is determined that the hand position information continuously matches the operation-unit surrounding-space position information until the comparison time has elapsed, the wake-up controller 25 exerts control so that the image processing apparatus 10 is woken up from the power-saving state and enters the normal state (step 205).

In this case, the hand-characteristics information acquiring unit 26 successively determines whether or not hand characteristics information indicating characteristics of the hand with which the operation unit is going to be operated has been obtained from the sensor 19 (step 206). If the hand-characteristics information acquiring unit 26 does not determine that hand characteristics information indicating characteristics of the hand with which the operation unit is going to be operated has been obtained from the sensor 19, the process proceeds to step 209.

If the hand-characteristics information acquiring unit 26 determines that hand characteristics information indicating characteristics of the hand with which the operation unit is going to be operated has been obtained from the sensor 19, the characteristics-information comparing unit 28 determines whether or not the obtained hand characteristics information matches any piece of the hand characteristics information included in the characteristics comparison information stored in the characteristics-comparison information memory 27 (step 207). Specifically, the characteristics-information comparing unit 28 determines whether or not the characteristics indicated in the obtained hand characteristics information fall within a predetermined range in which the characteristics at the center are the characteristics indicated by any piece of the hand characteristics information included in the characteristics comparison information. If the characteristics-information comparing unit 28 does not determine that the obtained hand characteristics information matches a piece of the hand characteristics information included in the characteristics comparison information, the process proceeds to step 209.

In contrast, if the characteristics-information comparing unit 28 determines that the obtained hand characteristics information matches a piece of the hand characteristics information included in the characteristics comparison information, the display controller 29 exerts control so that a UI screen is displayed on a display of the operation panel 15 in the display format indicated in the display format information that corresponds to the hand characteristics information in the characteristics comparison information and that is included in the characteristics comparison information (step 208).

If it is not determined that hand characteristics information indicating characteristics of the hand with which the operation unit is going to be operated has been obtained from the sensor 19 in step 206, or if the characteristics-information comparing unit 28 does not determine that the obtained hand characteristics information matches a piece of the hand characteristics information included in the characteristics comparison information in step 207, the display controller 29 exerts control so that a UI screen is displayed on the display of the operation panel 15 in the normal display format (step 209).

In these exemplary operations, in steps 206 to 209, a UI screen is displayed on the display in the display format according to hand characteristics information indicating the characteristics of a hand with which an operation unit is going to be operated. However, this process is not necessarily performed. That is, in the exemplary operations, when the image processing apparatus 10 is woken up from the power-saving state and enters the normal state in step 205, the process may end.

In the exemplary embodiment, a comparison time which is a time for which the hand position information is compared with the operation-unit surrounding-space position information is changed in accordance with the type of an operation unit. However, this is not limiting. For example, comparison times may be the same regardless of the types of operation units. Instead of being changed in accordance with the type of an operation unit, a comparison time may be changed in accordance with the environment in which the image processing apparatus 10 is used. Examples of the environment in which the image processing apparatus 10 is used include utilization conditions, such as a frequency of use and a utilization time of the image processing apparatus 10. In addition, the location of the image processing apparatus 10 is also such an example. For example, when the image processing apparatus 10 is installed in an office, not so many people pass by the image processing apparatus 10. Therefore, importance is placed on a wake-up operation of changing the state of the image processing apparatus 10 quickly from the power-saving state, and the comparison time may be set shorter. In contrast, when the image processing apparatus 10 is installed in a convenience store, many people pass by the image processing apparatus 10. Therefore, importance is placed on avoidance of erroneous detection, and the comparison time may be set longer.

In the exemplary embodiment, the display of the operation panel 15 which is provided for the image processing apparatus 10 is described as an operation unit. However, this is not limiting. For example, a large screen UI which is installed separately from the image processing apparatus 10 may be used as an operation unit. Instead, a coin slot of a coin operated machine attached to the image processing apparatus 10 may be used as an operation unit.

In the exemplary embodiment, the case in which, when the image processing apparatus 10 is in the power-saving state, the wake-up control device 20 in the image processing apparatus 10 performs a wake-up operation of changing the state of the image processing apparatus 10 from the power-saving state to the normal state is described. However, this is not limiting. When a certain device is in the power-saving state, the wake-up control device 20 which is provided outside the device may wake up the device from the power-saving state to the normal state.

### Program

The process performed by the wake-up control device 20 according to the exemplary embodiment is prepared, for example, as a program such as application software.

That is, the program for achieving the exemplary embodiment may be regarded as a program for causing a computer to implement the following functions: a function of, when an apparatus is in the power-saving state in which the power consumption is lower than that in the normal state, detecting a hand or finger approaching an operation unit operated in order to perform a wake-up operation of changing the state of the apparatus from the power-saving state to the normal state; and a function of, in the case where the apparatus is in the power-saving state, if a hand or finger approaching the operation unit is detected, performing a wake-up operation of changing the state of the apparatus from the power-saving state to the normal state even when the operation unit has not been operated.

The program for implementing the exemplary embodiment may be provided not only through a communication unit but also by storing the program in a recording medium such as a compact disc-read-only memory (CD-ROM).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A wake-up control device comprising:
a detector that, when an apparatus is in a power-saving state, the power-saving state being a state in which power consumption is lower than power consumption in a normal state, detects a hand or finger approaching an operation unit operated in order to perform a wake-up operation of changing a state of the apparatus from the power-saving state to the normal state; and
a wake-up unit that, in the case where the apparatus is in the power-saving state, if the detector detects a hand or finger approaching the operation unit, even when the operation unit has not been operated, performs a wake-up operation of changing the state of the apparatus from the power-saving state to the normal state.

2. The wake-up control device according to claim 1,
wherein the detector detects the hand or finger approaching the operation unit by detecting presence of a hand or finger in a predetermined space whose center is located at a position close to the operation unit.

3. The wake-up control device according to claim 2,
wherein the detector detects the hand or finger approaching the operation unit by detecting continuous presence of the hand or finger in the space for duration of a predetermined time.

4. The wake-up control device according to claim 3,
wherein the detector uses, as the predetermined time, a time according to a type of the operation unit or an environment in which the apparatus is used.

5. The wake-up control device according to claim 1, further comprising:
a display unit that displays information on a display screen for the operation unit in a format corresponding to a characteristic of the detected hand or finger approaching the operation unit.

6. An image processing apparatus comprising:
an operation unit that is operated when an instruction to perform image processing is to be transmitted, wherein, when the image processing apparatus is in a power-saving state, the power-saving state being a state in which power consumption is lower than power consumption in a normal state, the operation unit is operated in order to perform a wake-up operation of changing a state of the image processing apparatus from the power-saving state to the normal state; and
a wake-up unit that, in the case where the image processing apparatus is in the power-saving state, if a hand or finger approaches the operation unit, even when the operation unit has not been operated, performs a wake-up operation of changing the state of the image processing apparatus from the power-saving state to the normal state.

7. A non-transitory computer readable medium storing a program causing a computer to execute a process comprising:
when an apparatus is in a power-saving state, the power-saving state being a state in which power consumption is lower than power consumption in a normal state, detecting a hand or finger approaching an operation unit operated in order to perform a wake-up operation of changing a state of the apparatus from the power-saving state to the normal state; and
in the case where the apparatus is in the power-saving state, if a hand or finger approaching the operation unit is detected, even when the operation unit has not been operated, performing a wake-up operation of changing the state of the apparatus from the power-saving state to the normal state.
